(19) United States
(12) Patent Application Publication
(10) Pub. No.: US 2026/0158597 A1
(43) Pub. Date: Jun. 11, 2026

(54) WELDING INSPECTION SYSTEM

(71) Applicant: SK On Co., Ltd., Seoul (KR)

(72) Inventors: Seung Won LEE, Daejeon (KR); Hyo Sung HONG, Daejeon (KR); Jae Hun KIM, Daejeon (KR)

(21) Appl. No.: 19/404,013

(22) Filed: Dec. 1, 2025

(30) Foreign Application Priority Data
Dec. 11, 2024 (KR) 10-2024-0183758

(51) Int. Cl. B23K 31/12; B23K 26/03; B23K 26/70

(52) U.S. Cl. CPC B23K 31/125; B23K 26/032; B23K 26/70

(57) ABSTRACT

The present disclosure relates to a welding inspection system. The welding inspection system may comprise a welder that generates a laser beam, a laser emitter for irradiating a welding object with the laser beam and welding the welding object, a sensor for measuring a plasma intensity generated from the welding object, a shooting unit for shooting a weld formed on the welding object, and a judgment unit for analyzing the measured values from the sensor and the images obtained from the shooting unit to determine whether the welding object is defective.

### CROSS-REFERENCE TO RELATED PATENT APPLICATION

The present application claims priority under 35 U.S.C. § 119a to Korean patent application number 10-2024-0183758 filed on December 11, 2024, in the Korean Intellectual Property Office, the entire disclosure of which is incorporated by reference herein.

### BACKGROUND OF THE DISCLOSURE

### 1. Field

The present disclosure relates to an inspection system for a battery, and more particularly, to a welding inspection system for a battery.

### 2. Description of the Related Art

The demand for secondary batteries is increasing rapidly as a source of energy to power various electronic devices such as smartphones, laptops, vehicles, and drones. In particular, research on battery modules as secondary batteries for driving vehicles has been actively conducted.

In general, secondary batteries use laser welding to connect components electrically or mechanically, and it is important to maintain the quality of these welding.

In the inspection of welding quality, the detection techniques for each type of weld defect (pores, no welds, weak welds, etc.) include vision inspection, which shoots and inspects the weld surface, X-ray inspection, which uses infrared radiation to inspect the melting state of the weld, and human visual inspection, which is a direct visual inspection of the weld and direct shaking of the weld, and these welding inspection techniques have limitations.

However, vision inspection is a method that inspects changes in appearance through images and has the limitation of not being able to inspect the actual surface fusion of the weld.

In addition, X-ray inspection has the disadvantages of increased investment costs and increased administrative items because a special test environment must be built to prevent infrared radiation from being exposed to the operator's environment.

Visual inspection also has the disadvantage of low detection reliability due to its reliance on the operator.

In particular, a welding defect of the secondary battery may cause the performance of the secondary battery to deteriorate or fail, as well as short circuit inside the module of the secondary battery, which may cause fire or explosion.

Therefore, there is a need for a system that can accurately inspect the welding defects of a secondary battery.

The present disclosure is to provide a welding inspection system that can reduce the cost of weld quality inspection and effectively collect data related to weld quality.

According to one aspect of the present disclosure, an object is to provide a welding inspection system that combines in-weld inspection and post-weld inspection in determining whether a weld is defective during laser welding of a secondary battery.

According to another aspect of the present disclosure, an object is to provide a welding inspection system that detects defective welds of a secondary battery by checking whether the welds are defective inside the welds, even if there are no apparent defects in the laser welds of the secondary battery.

### SUMMARY OF THE DISCLOSURE

A welding inspection system according to an embodiment of the present disclosure may comprise: a welder that generates a laser beam; a laser emitter for irradiating a welding object with the laser beam and welding the welding object; a sensor for measuring a plasma intensity generated from the welding object; a shooting unit for shooting a weld formed on the welding object; and a judgment unit for analyzing the measured values from the sensor and the images obtained from the shooting unit to determine whether the welding object is defective.

In an embodiment, the measuring the plasma intensity may be performed during welding of the welding object.

In an embodiment, the shooting of the weld may be performed after completion of welding of the welding object.

In an embodiment, the measured values of the plasma intensity may include a time series data per wavelength band of the irradiated laser beam.

In an embodiment, the judgment unit may generate a Gaussian distribution region for the measured values of the plasma intensity from a good welding object, and may determine whether the measured values of the plasma intensity generated from the welding object are outside the Gaussian distribution region.

In an embodiment, the judgment unit may generate a Gaussian distribution region for the measured values of the plasma intensity from a good welding object, and may determine that the welding of the welding object is judged as a final defect when the number of data deviating from the Gaussian distribution region among the measured values of the plasma intensity from the welding object exceeds a predetermined reference value.

In an embodiment, the judgment unit may generate a Gaussian distribution region for the measured values of the plasma intensity from a good welding object, and may include an alarm unit for generating an alarm signal when the number of data within the Gaussian distribution region and adjacent to a boundary of the Gaussian distribution region among the measured values of the plasma intensity from the welding object is equal to or greater than a predetermined reference value.

In an embodiment, the judgment unit may generate a Gaussian distribution region for the measured values of the plasma intensity from a good welding object, and may analyze the images obtained from the shooting unit when the number of data deviating from the Gaussian distribution region among the measured values of the plasma intensity from the welding object is equal to or less than a predetermined reference value.

In an embodiment, the judgement unit may determine that the welding of the welding object is judged as a final good when it is not possible to analyze the image obtained from the shooting unit.

In an embodiment, the judgement unit may include a learning model having learned images of normal and abnormal welds before performing the welding inspection.

In an embodiment, the judgement unit may determine whether the welding object is defective by comparing the images obtained from the shooting unit with the learning model.

In an embodiment, the judgement unit may determine that the welding of the welding object is judged as a final good when the image obtained from the shooting unit is determined to be the image of normal weld.

In an embodiment, the judgement unit may add the image obtained from the shooting unit to the images of normal welds when the image obtained from the shooting unit is determined to be the image of normal weld.

In an embodiment, the judgement unit may determine that the welding of the welding object is judged as a final defect when the image obtained from the shooting unit is determined to be the image of abnormal weld.

In an embodiment, the judgement unit may add the image obtained from the shooting unit to the images of abnormal welds when the image obtained from the shooting unit is determined to be the image of abnormal weld.

In an embodiment, the welding inspection system may further comprise: a display unit for displaying a result of the judgment of the judgment unit.

One embodiment of the present disclosure may provide a new type of welding inspection system.

One embodiment of the present disclosure may provide a welding inspection system with improved detection of defects.

One embodiment of the present disclosure may provide a welding inspection system capable of determining whether a weld is defective, which is not possible by visual detection alone, and whether a weld is defective, which is not possible by plasma detection alone.

One embodiment of the present disclosure may provide a welding inspection system that is adaptable to changes that may occur over time in a battery manufacturing process through learning from welding inspection data.

One embodiment of the present disclosure may provide a welding inspection system capable of improving the quality of batteries by proactively preventing defective welds in batteries.

The welding inspection system according to one embodiment of the present disclosure may be widely applied in the field of green technology, such as electric vehicles, battery charging stations, energy storage systems, photovoltaics, wind power, and other fields that utilize battery cells.

Furthermore, the welding inspection system according to one embodiment of the present disclosure may be used in eco-friendly mobility, including electric vehicles and hybrid vehicles to prevent climate change by reducing air pollution and greenhouse fluid emissions.

### BRIEF DESCRIPTION OF THE DRAWINGS

FIG. 1 is a diagram for illustrating schematically a welding inspection system according to one embodiment of the present disclosure.

FIG. 2 is a flow chart for schematically illustrating steps for determining a welding defect in a welding inspection system according to one embodiment of the present disclosure.

FIG. 3 is a schematic illustration of a Gaussian distribution region using Gaussian processing applied to measured values of plasma intensity according to one embodiment of the present disclosure.

FIG. 4A and FIG. 4B are schematic illustrations of determining whether a weld is defective by determining measured values of plasma intensity according to one embodiment of the present disclosure.

FIG. 5 is a schematic illustration of determining whether a weld is defective by determining measured values of plasma intensity according to another embodiment of the present disclosure.

FIG. 6 is a schematic illustration of determining whether a weld is defective by determining measured values of plasma intensity and shot images according to one embodiment of the present disclosure.

FIG. 7 is a schematic illustration of a visualization of whether a weld is defective through a display unit according to one embodiment of the present disclosure.

### DETAILED DESCRIPTION

Hereinafter, a welding inspection system according to various embodiments of the present disclosure will be described with reference to the accompanying drawings with reference to a preferred embodiment of the present disclosure.

As a preliminary to the description, it should be noted that when an aspect is said to “comprise” or "include" a component, it is meant to be inclusive of other components, not exclusive of other components, unless specifically noted to the contrary.

In addition, in various embodiments, components having the same configuration will be described in a representative embodiment using the same symbols, while in other embodiments only different components will be described.

The structural or functional descriptions of embodiments disclosed in this specification or application are exemplified for purposes of illustrating embodiments in accordance with the technical ideas of the present disclosure only, and embodiments in accordance with the technical ideas of the present disclosure may be implemented in various forms other than those disclosed in this specification or application, and the technical ideas of the present disclosure shall not be construed to be limited to the embodiments described in this specification or application.

As used herein, a battery may include a battery cell, a cell, a secondary battery or a battery of cells.

With reference to the following drawings, a welding inspection system 1 according to various embodiments of the present disclosure will be described in more detail.

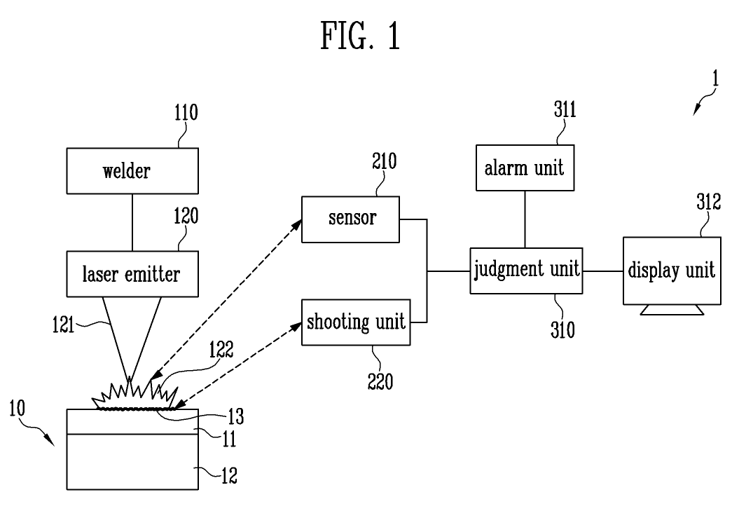

FIG. 1 is a diagram for illustrating schematically a welding inspection system according to one embodiment of the present disclosure.

As shown in FIG. 1, a welding inspection system 1 may comprise a welder 110 that generates a laser beam, a laser emitter 120 for irradiating a welding object 10 with the laser beam 121 and welding the welding object 10, a sensor 210 for measuring a plasma 122 intensity generated from the welding object 10, a shooting unit 220 for shooting a weld 13 formed on the welding object 10, and a judgment unit 310 for analyzing the measured values from the sensor 210 and the images obtained from the shooting unit 220 to determine whether the welding object 10 is defective.

For example, the welder 110 may be a laser welder, which may also be referred to as a laser generator. Alternatively, the welder 110 may be a YAG laser welder, for example. The welder 110 may function to generate a laser for laser welding. In general, laser welding involves irradiating a focused laser beam 121 onto a surface of a material and then melting it to form a weld. Welding using the laser beam 121 has the advantages of low deformation and shrinkage, fast welding speed, and easy automation.

In addition, since the welding is mostly performed by alloying the welding object 10 without using filler metal, welding of inaccessible members is possible, and various materials including non-conductive weldments may be welded, and welding of dissimilar materials can be successfully performed.

Laser welding processes include heat conduction type, deep penetration type, plasma bead type, and the like. Furthermore, the laser emitter 120 may comprise an optical system for projecting a laser generated by the welder 110 onto the welding object 10. The welder 110 and the laser emitter 120 may be connected by laser fibers (not shown).

In one embodiment of the present disclosure, the welding object 10 may be arranged in various configurations. For example, the welding object 10 may include a first welding object 11 and a second welding object 12 that is welded to the first welding object 11.

Specifically, the first welding object 11 may be at least one electrode tab electrically coupled to an electrode assembly including an electrode and a separator, and the second welding object 12 may be a current collector electrically coupled to such an electrode tab. Further, the first welding object 11 may be a case of the electrode assembly, and the second welding object 12 may be a current collector in electrical connection with such a case. Further, the first welding object 11 may be a case of an electrode assembly, and the second welding object 12 may be a cap assembly in electrical connection with such case.

Further, such first welding object 11 may be welded to the second welding object 12 in at least one area. On the other hand, in welding joining the first welding object 11 to the second welding object 12, the quality of the weld may vary depending on the material difference between the first welding object 11 and the second welding object 12, the welding temperature, the welding time, and the like.

In one embodiment of the present disclosure, the sensor 210 may perform a function of sensing a wavelength of the reflected plasma 122 reflected from the welding object 10 to generate a sensing wavelength. For example, the sensor 210 may utilize a sensor that measures the intensity of the reflected plasma 122 upon irradiation by the laser beam 121 to produce measured values. For example, the sensor 210 may be attached to the laser emitter 120, or may be externally mounted and measured separately.

In one embodiment of the present disclosure, the shooting unit 220 may obtain an image of the weld 13 formed on the welding object 10. For example, the shooting unit 220 may shoot the position of the welding object 10, the weld 13, and the process by which the laser beam 121 is irradiated. For example, the shooting unit 220 may include a 2D vision camera for obtaining an image of at least one area of the welding object 10, which may be attached to the laser emitter 120 or may be externally mounted separately. It may also be arranged on a coaxial axis with the welding object 10, or may be disposed in various orientations with respect to the welding object 10.

In one embodiment of the present disclosure, the judgment unit 310 may analyze the measured values with the sensor 210 described above and the images obtained from the shooting unit 220 to determine whether the weld on the welding object 10 is defective, and a specific method of determining the defect will be described later.

For example, the judgment unit 310 refers to a unit that handles at least one function or operation, which may be implemented as hardware or software or a combination of hardware and software. For example, in the case of hardware, it may be implemented as an application specific integrated circuit, digital signal processing, programmable logic device, field programmable gate array, processor, controller, microprocessor, other electronic unit, or a combination thereof, designed to perform the functions described above. For example, the software implementation may be implemented as modules that perform the functions described above. The software may be stored in a memory unit and executed by a processor. The memory unit or processor may employ a variety of means well known to those skilled in the art.

In addition, in one embodiment of the present disclosure, the judgment unit 310 may include a storage portion (not shown) for storing data, a program for analyzing a waveform according to a digital wavelength signal, performing an algorithm for comparing the analyzed waveform to a preset boundary line to determine a type of welding defect of a weld on the welding object 10, and the processed signal, and the like.

For example, the storage portion may be a memory provided within the judgment unit 310, or it may be a separate memory. Thus, it may be a solid state disk, hard disk drive, flash memory, electrically erasable programmable read-only memory, static RAM, Ferro-electric RAM, Phase-change RAM, Magnetic RAM, and/or any combination of non-volatile memory and/or volatile memory such as Dynamic Random Access Memory, Synchronous Dynamic Random Access Memory, Double Date Rate-SDRAM, and the like.

In one embodiment of the present disclosure, the alarm unit 311 may alarm an alarm signal to an operator upon obtaining a predetermined judgment result from the aforementioned judgment unit 310.

In one embodiment of the present disclosure, the display unit 312 can display the judgment result of the aforementioned judgment unit 310, and may provide the operator with a visualization of the cause of the defective judgment of the welding object 10 at the manufacturing site.

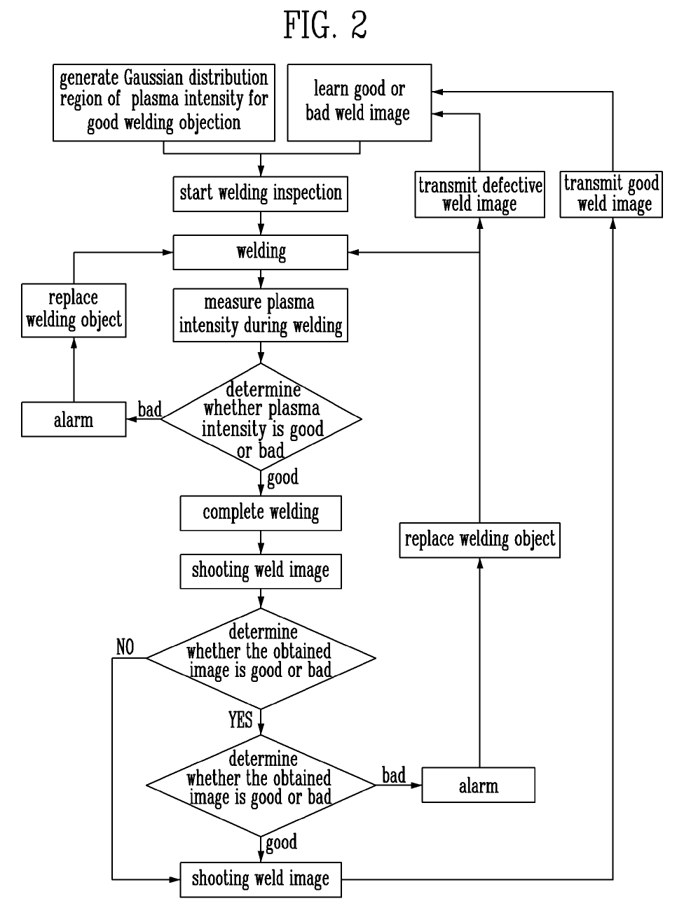

FIG. 2 is a flow chart for schematically illustrating steps for determining a welding defect in a welding inspection system 1 according to one embodiment of the present disclosure.

For example, the measuring the plasma 122 intensity may be performed during welding of the welding object 10, and the shooting of the weld 13 may be performed after completion of welding of the welding object 10.

When the welding object 10 is irradiated with the laser beam 121, reflected plasma 122 is generated. As described above, this is accomplished by sensing only a predetermined wavelength of such reflected plasma 122 through the sensor 210, i.e., not all reflected plasma 122 is sensed, but only the predetermined required reflected plasma 122 is sensed, and its intensity is measured to produce measured values, and the measured values of the plasma 122 intensity may include a time series data per wavelength band of the irradiated laser beam 121.

In one embodiment of the present disclosure, the judgment unit 310 may generate a Gaussian distribution region A for the measured values of the plasma 122 intensity from a good welding object 10, and determines whether the measured values of the plasma 122 intensity generated from the welding object 10 are outside the Gaussian distribution region A.

For example, the judgment unit 310 may pre-generate a Gaussian distribution region A for the plasma 122 intensity measurements originating from the welding object 10 of both articles in advance, and determine whether the plasma 122 intensity measurements originating from the welding object 10 that are subject to weld inspection fall outside the pre-generated Gaussian distribution region A.

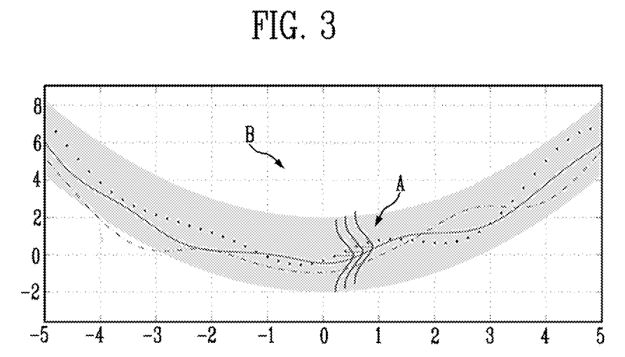

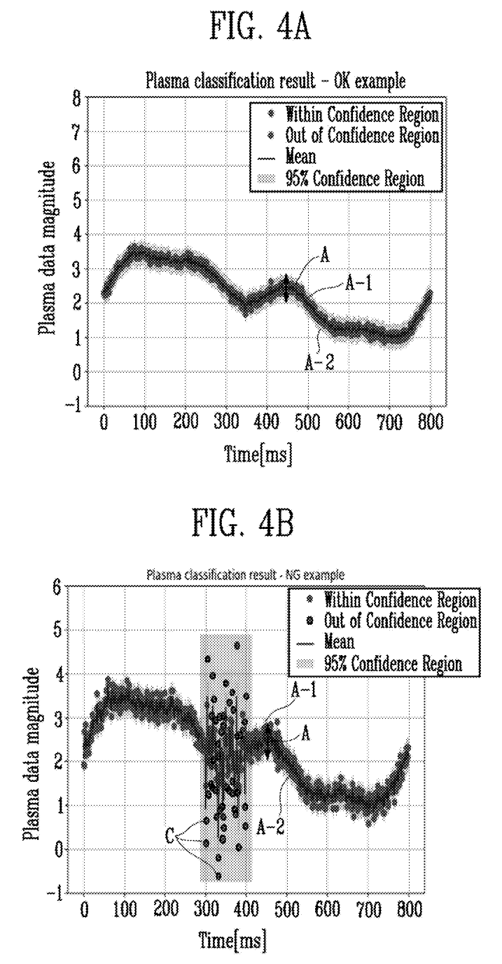

FIG. 3 is a schematic illustration of a Gaussian distribution region A using Gaussian processing applied to measured values of plasma 122 intensity according to one embodiment of the present disclosure, and FIG. 4A and FIG. 4B are schematic illustrations of determining whether a weld is defective by determining measured values of plasma 122 intensity according to one embodiment of the present disclosure.

For example, based on a Gaussian process model trained by a Gaussian process model kernel optimization through time series data training of 30 or more good products in advance, an upper limit A-1 and a lower limit A-2 category for determining a good weld may be calculated to generate a Gaussian distribution region A, respectively.

For example, μ and σ represent the predicted mean and predicted standard deviation, which are the return values of the Gaussian model, respectively, and the upper limit A-1 can be calculated as μ+CI*σ and the lower limit A-2 as μ-CI*σ, and the CI for a positive decision with 95% confidence is 1.95, and the CI for a positive decision with 99% confidence is 2.576.

For example, time series data that falls in the center of the upper limit A-1 and lower limit A-2 bounds can be assigned a NG score of 0, and time series data that falls to the center of the range of the upper A-1 and lower A-2 can be assigned a higher NG score. Further, the judgment of the degree of closeness to the categories of the upper limit A-1 and lower limit A-2 is based on a distance calculation value (distance in the y-axis) between the category regions of the upper limit A-1 and lower limit A-2 and the real-time data, and may be set differently depending on the weld 13 and the welding object 10.

In addition, in the case of time series data that falls outside the range of the upper limit A-1 and lower limit A-2, the length of the defect may be calculated based on the measured time and the laser irradiation speed value, and the defect may be judged as a defect if it is greater than a certain length value.

For example, the length of a defective weld v*△t can be calculated from the amount of time change △t when there are consecutive data points that exceed the upper limit A-1 and lower limit A-2 categories, which is the movement speed v of the laser beam between laser welds. However, the number of consecutive points to count as defects may vary from one welding process to another, and the length of the weld defect may be calculated by scaling the sampling frequency of the measurement equipment of the plasma 122 intensity to the length of the weld, as well as the laser welding speed.

In one embodiment of the present disclosure, the judgment unit 310 may generate a Gaussian distribution region A for the measured values of the plasma 122 intensity from a good welding object 10, and may determine that the welding of the welding object 10 is judged as a final defect when the number of data C deviating from the Gaussian distribution region A among the measured values of the plasma 122 intensity from the welding object 10 exceeds a predetermined reference value.

For example, the judgment unit 310 may generate a Gaussian distribution region A for the plasma 122 intensity measured values originating from the welding object 10 of both articles, and determine that the weld of the welding object 10 is ultimately defective if the number of data C of the plasma 122 intensity measured values originating from the welding object 10 falling outside the Gaussian distribution region A exceeds a predetermined reference.

As shown in FIG. 4A and FIG. 4B, the number of data C falling outside the Gaussian distribution region A is determined, and depending on whether the number is more or less than a certain reference number, a first determination of good or bad can be made, and a final determination of good or bad can be made by referring to the image to be described later.

For example, if the number of data outside the 90% to 99% confidence zone that can be set by the operator is greater than a certain reference number, the object may be judged as defective as a first step, and the object that is judged as defective as a first step is finally judged as defective because it is a type of defect that cannot be identified from the appearance of the weld 13, even if it is judged as good in the inspection of the image to be described later.

In other words, in one embodiment of the present disclosure, the judgment unit 310 may generate a Gaussian distribution region A for the measured values of the plasma 122 intensity from a good welding object, and may analyze the images obtained from the shooting unit 220 when the number of data C deviating from the Gaussian distribution region A among the measured values of the plasma intensity from the welding object 10 is equal to or less than a predetermined reference value. Further, in one embodiment of the present disclosure, the judgement unit 310 may determine that the welding of the welding object 10 is judged as a final good when it is not possible to analyze the image obtained from the shooting unit 220.

For example, it is preferable to analyze the image obtained from the shooting unit 220 when the judgment unit 310 generates a Gaussian distribution region A for the plasma 122 intensity measured values generated from the welding object 10 of the two articles, and the number of data C that the plasma 122 intensity measured values generated from the welding object 10 fall outside the Gaussian distribution region A is less than or equal to a predetermined reference value. However, even in this case, if it is not possible to analyze the image obtained from the shooting unit 220, the final determination of the defect can only be made by determining the plasma 122 intensity measured values described above.

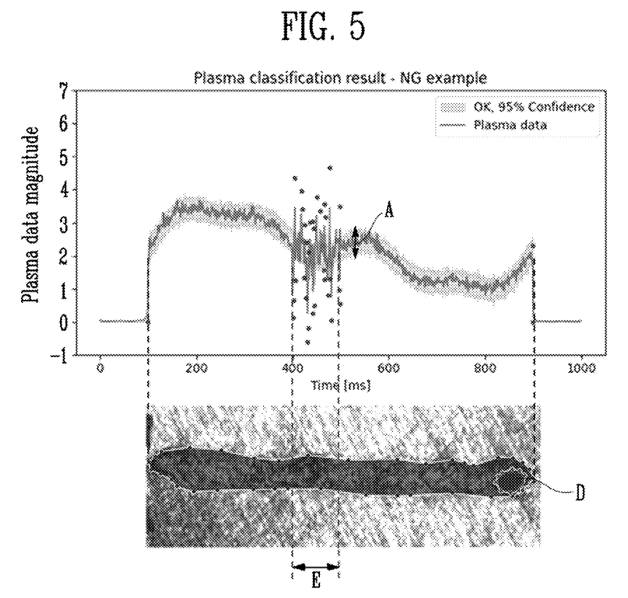

FIG. 5 is a schematic illustration of determining whether a weld is defective by determining measured values of plasma intensity according to another embodiment of the present disclosure.

In one embodiment of the present disclosure, the judgment unit 310 may generate a Gaussian distribution region A for the measured values of the plasma intensity from a good welding object, and includes an alarm unit 311 for generating an alarm signal when the number of data F within the Gaussian distribution region and adjacent to a boundary of the Gaussian distribution region A among the measured values of the plasma 122 intensity from the welding object 10 is equal to or greater than a predetermined reference value.

For example, the judgment unit 310 may alarm the operator via an alarm signal from the alarm unit 311 if the plasma 122 intensity measured values generated from the weld object 10 is within the Gaussian distribution region A described above, but the number of data F adjacent to the boundary value of the Gaussian distribution region A is above a predetermined reference.

For example, the alarm signal may be a combination of graphics, text, and voice. Accordingly, the operator can stop the process, identify the cause of the failure, and take action.

For example, as shown in FIG. 5, if the plasma 122 intensity measured values is above a certain number of data F adjacent to the upper limit A-1 or lower limit A-2 of the reference value, an anomaly in the equipment or weld 13 is continuously being fed into the process, and the alarm signal can be alerted to an operator via the alarm unit 311 to perform a routine or irregular process check of the manufacturing site before a large-scale failure occurs in the manufacturing process.

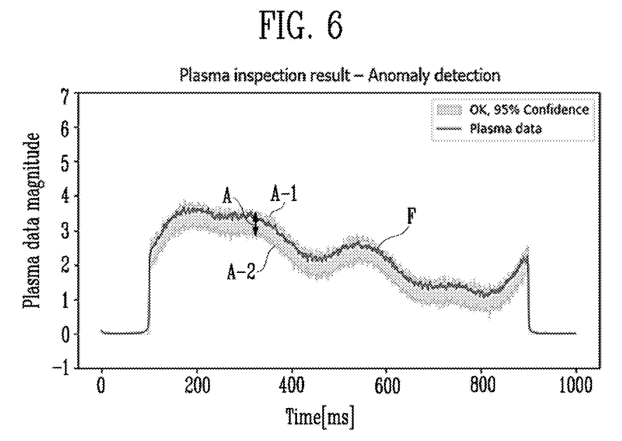

FIG. 6 is a schematic illustration of determining whether a weld is defective by determining measured values of plasma 122 intensity and shot images according to one embodiment of the present disclosure.

As shown in FIGS. 2 and 6, when the number of data C falling outside the Gaussian distribution region A of the plasma 122 intensity measured values originating from the weld object 10 is less than or equal to a predetermined reference value, it is desirable to analyze the image obtained from the shooting unit 220 as a next step.

In one embodiment of the present disclosure, the judgement unit 310 may include a learning model having learned images of normal and abnormal welds before performing the welding inspection.

For example, the judgment unit 310 may include a learning model that has been trained on images of normal and abnormal welds in advance of performing the weld inspection.

For example, in one embodiment of the present disclosure, the judgment unit 310 may generate a learning model for AI-based weld quality inspection and use the generated learning model to inspect the weld 13 for defects by comparing it to the AI-based learning model.

In one embodiment of the present disclosure, the judgement unit 310 may determine whether the welding object 10 is defective by comparing the images obtained from the shooting unit 220 with the learning model.

For example, the image obtained from the shooting unit 220 may be compared to the generated learning model to determine whether the welding object 10 is defective.

In one embodiment of the present disclosure, the judgement unit may determine that the welding of the welding object 10 is judged as a final good when the image obtained from the shooting unit 220 is determined to be the image of normal weld, and may add the image obtained from the shooting unit 220 to the images of normal welds when the image obtained from the shooting unit 220 is determined to be the image of normal weld.

For example, if the image obtained from the shooting unit 220 is determined to be a normal weld image in the learning model, the weld of the welding object 10 may be determined to be a final good product, and further, the image determined to be a final good product may be added to the normal weld image in the learning model.

In one embodiment of the present disclosure, the judgement unit may determine that the welding of the welding object is judged as a final defect when the image obtained from the shooting unit is determined to be the image of abnormal weld, and add the image obtained from the shooting unit to the images of abnormal welds when the image obtained from the shooting unit is determined to be the image of abnormal weld.

For example, if the image obtained from the shooting unit 220 is determined to be an abnormal weld image in the learning model, the weld of the welding object 10 may be determined to be a final defect, and the image determined to be a final defect may be added to the abnormal weld image in the learning model.

Thus, by continuously adding normal and abnormal image data of the weld 13 to the learning model stored in the judgment unit 310, a learning model with high weld quality inspection performance can be continuously generated, and an effective and fast inspection result of the weld 13 can be derived based on the generated learning model, which has the advantage that a large number of weldments 13 can be inspected with minimal time and cost.

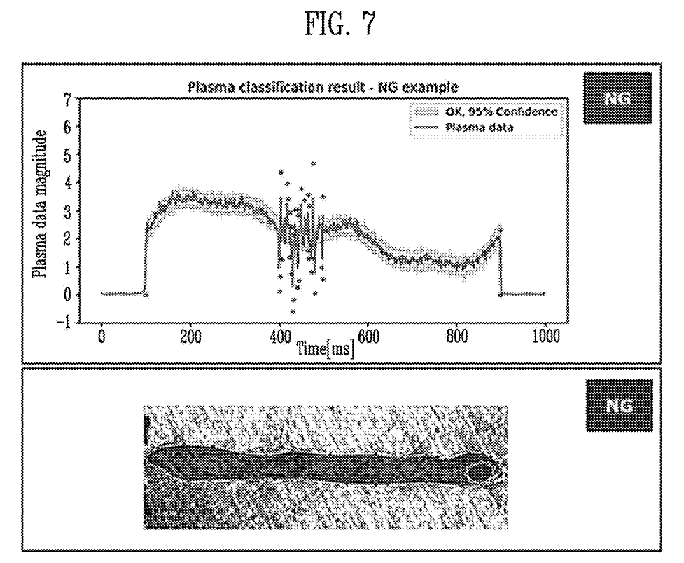

FIG. 7 is a schematic illustration of a visualization of whether a weld is defective through a display unit according to one embodiment of the present disclosure.

In one embodiment of the present disclosure, the welding inspection system 1 may further comprise a display unit 312 for displaying a result of the judgment of the judgment unit.

For example, the display unit 312 may display the results of the judgment of the judgment unit 310 on a screen for visualization.

For example, the display unit 312 may display analytical information analyzing whether measured values of the plasma 122 intensity are within or exceeds the upper limit A-1 and lower limit A-2 of the Gaussian distribution region A in real time, through waveform analysis by type of welding defect, for the operator to understand.

For example, as shown in FIG. 7, the display unit 312 can display the result of whether the weld is defective and the determined plasma 122 intensity measured values through a determination of the plasma 122 intensity measured values during welding, and the result of whether the weld is defective and the determined plasma 122 intensity measured values through a determination based on the acquired image obtained with the shooting unit 220 after welding. Thus, the operator can be provided with a visualization of the defective condition and the cause of the determination at the manufacturing site.

In view of the foregoing description, it will be understood by those skilled in the art to which the present invention belongs that the present disclosure may be practiced in other specific forms without altering its technical ideas or essential features.

The scope of the present disclosure is indicated by the following patent claims rather than by the foregoing detailed description, and the meaning and scope of the patent claims and all modifications or variations derived from the same concept should be construed to be included within the scope of the invention.

What is claimed is:

1. A welding inspection system comprises:
a welder that generates a laser beam;
a laser emitter for irradiating a welding object with the laser beam and welding the welding object;
a sensor for measuring a plasma intensity generated from the welding object;
a shooting unit for shooting a weld formed on the welding object; and
a judgment unit for analyzing the measured values from the sensor and the images obtained from the shooting unit to determine whether the welding object is defective.

2. The welding inspection system according to claim 1, wherein the measuring the plasma intensity is performed during welding of the welding object.

3. The welding inspection system according to claim 1, wherein the shooting of the weld is performed after completion of welding of the welding object.

4. The welding inspection system according to claim 1, wherein the measured values of the plasma intensity includes a time series data per wavelength band of the irradiated laser beam.

5. The welding inspection system according to claim 4, wherein the judgment unit generates a Gaussian distribution region for the measured values of the plasma intensity from a good welding object, and determines whether the measured values of the plasma intensity generated from the welding object are outside the Gaussian distribution region.

6. The welding inspection system according to claim 4, wherein the judgment unit generates a Gaussian distribution region for the measured values of the plasma intensity from a good welding object, and determines that the welding of the welding object is judged as a final defect when the number of data deviating from the Gaussian distribution region among the measured values of the plasma intensity from the welding object exceeds a predetermined reference value.

7. The welding inspection system according to claim 4, wherein the judgment unit generates a Gaussian distribution region for the measured values of the plasma intensity from a good welding object, and includes an alarm unit for generating an alarm signal when the number of data within the Gaussian distribution region and adjacent to a boundary of the Gaussian distribution region among the measured values of the plasma intensity from the welding object is equal to or greater than a predetermined reference value.

8. The welding inspection system according to claim 4, wherein the judgment unit generates a Gaussian distribution region for the measured values of the plasma intensity from a good welding object, and analyzes the images obtained from the shooting unit when the number of data deviating from the Gaussian distribution region among the measured values of the plasma intensity from the welding object is equal to or less than a predetermined reference value.

9. The welding inspection system according to claim 8, wherein the judgement unit determines that the welding of the welding object is judged as a final good when it is not possible to analyze the image obtained from the shooting unit.

10. The welding inspection system according to claim 4, wherein the judgement unit includes a learning model having learned images of normal and abnormal welds before performing the welding inspection.

11. The welding inspection system according to claim 10, wherein the judgement unit determines whether the welding object is defective by comparing the images obtained from the shooting unit with the learning model.

12. The welding inspection system according to claim 11, wherein the judgement unit determines that the welding of the welding object is judged as a final good when the image obtained from the shooting unit is determined to be the image of normal weld.

13. The welding inspection system according to claim 12, wherein the judgement unit adds the image obtained from the shooting unit to the images of normal welds when the image obtained from the shooting unit is determined to be the image of normal weld.

14. The welding inspection system according to claim 11, wherein the judgement unit determines that the welding of the welding object is judged as a final defect when the image obtained from the shooting unit is determined to be the image of abnormal weld.

15. The welding inspection system according to claim 14, wherein the judgement unit adds the image obtained from the shooting unit to the images of abnormal welds when the image obtained from the shooting unit is determined to be the image of abnormal weld.

16. The welding inspection system according to claim 1, further comprising:
a display unit for displaying a result of the judgment of the judgment unit.
